(19) United States
(12) Patent Application Publication
(10) Pub. No.: US 2018/0237116 A1
(43) Pub. Date: Aug. 23, 2018

(54) INSERTS FOR SUBSEA SYSTEMS

(71) Applicant: FORUM US, INC., Houston, TX (US)

(72) Inventors: Heinrich BARTELS, Houston, TX (US); Venkatkrishna RAGHAVENDRAN, Houston, TX (US); Pinkeshkumar ATTARWALA, Houston, TX (US); Thomas MITTNER, Cypress, TX (US)

(21) Appl. No.: 15/439,274

(22) Filed: Feb. 22, 2017

(51) Int. Cl. B63G 8/04; B63G 8/00; B32B 5/18; B32B 27/06

(52) U.S. Cl. CPC B63G 8/04; B63G 8/001; E21B 17/012; B32B 27/06; B63G 2008/005; B32B 5/18

(57) ABSTRACT

A subsea system having a coated insert at least partially embedded within a buoyant member of the device. The insert includes a retention member configured to attach a peripheral device to the buoyant member. The compliant layer on the insert is disposed between the insert and the buoyant member.

### BACKGROUND

### Field

Embodiments of the disclosure relate to inserts for subsea systems, such as remotely operated vehicles, pipelines, subsea tooling, survey markers, and drilling risers.

### Description of the Related Art

Numerous subsea systems, such as remotely operated vehicles, pipelines, subsea tooling, survey markers, and drilling risers are used in offshore, shallow water, and deep water oil and gas exploration and production operations. These subsea systems are often equipped with a buoyant member that provides some buoyancy to counterbalance some of the weight of the subsea system so that it can be handled and maintained efficiently underwater. The buoyant member is typically made of foam and includes multiple inserts, such as metallic nuts and/or bolts, at least partially embedded in the foam. In some instances, the inserts are used to attach peripheral devices to the subsea system, such as lifting eyes or protective panels. The inserts however are subject to various loads, such as shear forces and bending moments, which cause cracks in the more brittle buoyant member.

Therefore, there is a need for new and/or improved inserts for subsea systems.

### SUMMARY

In one embodiment, a subsea system comprises a buoyant member; an insert at least partially embedded within the buoyant member, wherein the insert comprises a retention member configured to attach a peripheral device to the buoyant member; and a compliant layer disposed between the insert and the buoyant member.

### BRIEF DESCRIPTION OF THE DRAWINGS

So that the manner in which the above-recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a side view of a subsea system, according to one embodiment.

FIG. 2A is a front view of an insert for a subsea system, according to one embodiment.

FIG. 2B is a sectional view of the insert of FIG. 2A taken along line 2B-2B, according to one embodiment.

FIG. 3A is a sectional view of another insert embedded within a buoyant member, according to one embodiment.

FIG. 3B is a sectional view of another insert embedded within a buoyant member, according to one embodiment.

FIG. 3C is a sectional view of another insert embedded within a buoyant member, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the disclosure relate to inserts and a compliant layer at least partially embedded within a buoyant member of a subsea system, such as remotely operated vehicles, pipelines, subsea tooling, survey markers, and drilling risers. Although described herein with respect to an underwater remotely operated vehicle, the inserts can be embedded within a buoyant member of any other type of subsea system. Also, although described herein as being embedded within a buoyant member, the inserts can be embedded within any other type of material to minimize or eliminate cracking or other similar type of damage to such material.

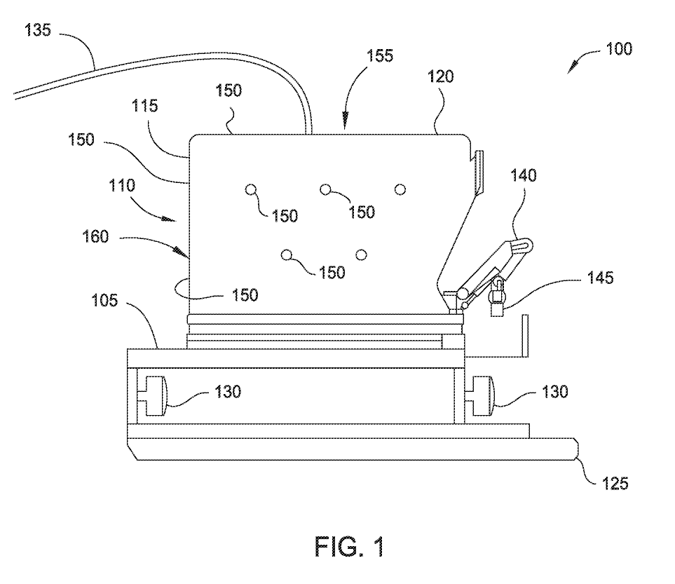

FIG. 1 is a side view of a subsea system 100, such as a remotely operated vehicle (ROV). The subsea system 100 includes a frame 105 coupled to a body 110. The body 110 has a housing 115 at least partially enclosing one or more operational components of the subsea system 100, such as pumps, electronics, motors, and/or other components necessary for operation of the subsea system 100. The frame 105 may include landing gear 125 and a plurality of thrusters 130 for propulsion of the subsea system 100. The subsea system 100 may be coupled to a tether 135 configured to provide power, communications, and control to the subsea system 100. The subsea system 100 may also include a robotic arm 140 and an end clamp 145 for manipulating objects in proximity to the subsea system 100.

The housing 115 is formed out of a material that will float in water so that the housing 115 can be used as a buoyant member 120 for the subsea system 100. The buoyant member 120 may be formed out of a composite material comprised of a void material and a polymer matrix material, to provide buoyancy to the subsea system 100. In one embodiment, the buoyant member 120 comprises composite closed cell foam. The buoyant member 120 is used to counterbalance some of the weight of the subsea system 100 when underwater to enhance the stability and reduce the need for external means of maintaining position of the subsea system 100 during operation.

One or more inserts 150 are disposed in (e.g. at least partially embedded in) the buoyant member 120. For example, the inserts 150 can be molded in place with and when the buoyant member 120 is cast. At least a portion of each insert 150 is visible and/or accessible from a top surface 155 of the buoyant member 120, as well as from side surfaces 160 of the buoyant member 120.

Each insert 150 includes one or more retention members used to attach peripheral devices to the buoyant member 120 of the subsea system 100, such as lifting eyes to lift the subsea system 100 or protective panels to protect the subsea system 100 from damage. The inserts 150 may be formed out of a metallic material, a ceramic material, a polymer material, or any other type of material configured to attach peripheral devices to the buoyant member 120. The inserts 150 may include one or more retention members, such as nuts, bolts, and/or a threaded sleeve having male or female threads that are exposed at the top surface 155 and side surfaces 160 of the buoyant member 120.

A compliant layer forms a flexible barrier between the material that the inserts 150 are formed from (e.g. metal, which is a hard and stiff material) and the material that the buoyant member 120 is formed from (e.g. foam, which is a brittle material). The compliant layer surrounding the inserts 150 helps eliminate or minimize cracking of the buoyant member 120 due to any loads applied to the inserts 150, such as when lifting the subsea system 100 from lifting eyes that are coupled to the subsea system 100 by the inserts 150. In particular, the compliant layer allows the load to be distributed over a greater area of the buoyant member 120, thereby reducing the probability of cracking. In one embodiment, the compliant layer is a coating applied to the inserts 150.

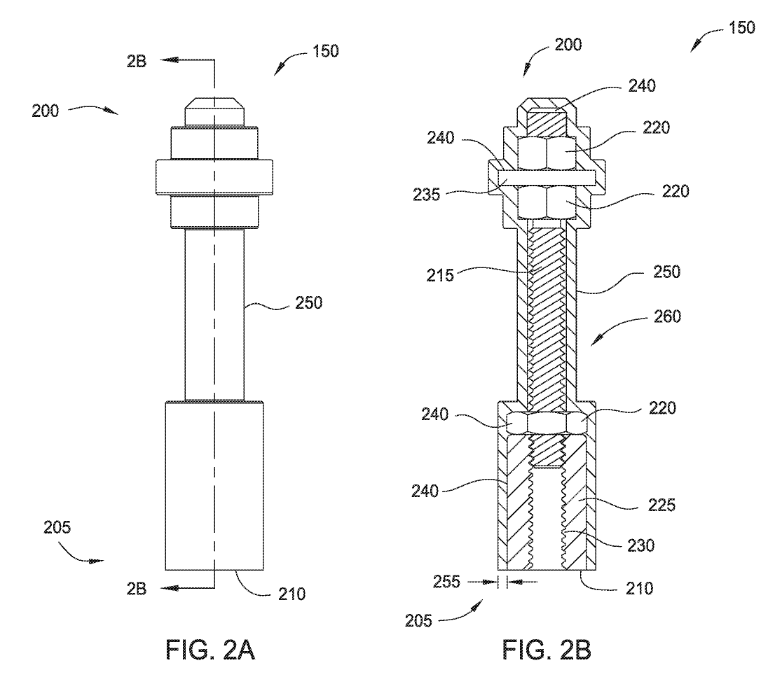

FIG. 2A is a front view of one insert 150 for use with the subsea system 100, according to one embodiment. FIG. 2B is a sectional view of the insert 150 of FIG. 2A taken along line 2B-2B. The insert 150 includes a first end 200 that may be embedded within the buoyant member 120 of FIG. 1. The insert 150 also includes a second end 205 opposite the first end 200 that includes a surface 210 that would be exposed from any of the surfaces of the buoyant member 120 of FIG. 1.

The insert 150 includes a retention member comprising a threaded bolt 215, a plurality of nuts 220, a washer 235, and a threaded sleeve 225. The threaded sleeve 225 includes female threads 230 for attachment of a peripheral device, such as lifting eyes or protective panels. The washer 235 is threaded to the threaded bolt 215 and disposed between two of the nuts 220. Although the retention member of the inserts 150 is described as having threads for connection to the peripheral device, the retention member of the inserts 150 may be a bayonet, a hook and tiedown loop, or any other similar type of connection.

In another embodiment, the insert 150 may be a single machined component or a single cast component that combines all retention features, such as a monolithic body having one or more portions with threaded members (e.g. external and/or internal threads).

A compliant layer 250 is disposed between the insert 150 and the buoyant member 120. In one embodiment, the compliant layer 250 is applied to exterior surfaces 240 of the insert 150 so that a barrier is formed between the buoyancy member 120 and the insert 150. In another embodiment, the compliant layer 250 is applied to exterior surfaces of the buoyance member 120 where the inserts 150 are to be positioned so that a barrier is formed between the buoyancy member 120 and the insert 150.

In one embodiment, the entire exterior surfaces 240 of the insert 150 are covered with the compliant layer 250. In another embodiment, the entire exterior surfaces 240 of the insert 150 that are to be in contact with the buoyant member 120 are covered with the compliant layer 250. In another embodiment, one or more portions of the exterior surfaces 240 of the insert 150 are covered with the compliant layer 250.

In one embodiment, the compliant layer 250 may be sprayed onto the exterior surfaces 240 of the insert 150 and/or the exterior surfaces of the buoyant member 120 where the insert 150 is to be positioned. In another embodiment, the insert 150 may be dipped into the compliant layer 250 while in a liquid state and then cured. In another embodiment, the compliant layer 250 may be applied by a molding process.

The compliant layer 250 may be an elastomeric material, such as a natural or synthetic polymer. In one embodiment, the compliant layer 250 may be a polycarbonate. In another embodiment, the compliant layer 250 may be a polyepoxide. In another embodiment, the compliant layer 250 may be polyurethane. In another embodiment, the compliant layer 250 may be rubber. In another embodiment, the compliant layer 250 may be high density polyethelene. In another embodiment, the compliant layer 250 may be a fluoroelastomer (FKM). In another embodiment, the compliant layer 250 may be a acrylonitrile butadiene styrene (ABS). In another embodiment, the compliant layer 250 may comprise one or more of polycarbonate, polyepoxide, polyurethane, rubber, high density polyethelene, fluoroelastomer (FKM), and acrylonitrile butadiene styrene (ABS).

While all of the exterior surfaces 240 of the insert 150 are shown in FIG. 2B as having the compliant layer 250 thereon, in some embodiments, only select portions of the exterior surfaces 240 may have the compliant layer 250. For example, only high stress areas of the insert 150 may need to have the compliant layer 250. For a further example, the first end 200 and the second end 205 may include the compliant layer 250 while a central portion 260 between the first end 200 and the second end 205 may remain bare, without the compliant layer 250.

In one embodiment, the compliant layer 250 may be formed out of a certain material on one portion (e.g. central portion 260) of the insert 150 and be formed out of a different material on another portion (e.g. first end 200) of the same insert 150.

One or more of the exterior surfaces 240 may be prepped prior to applying the compliant layer 250 to ensure a strong bond between the exterior surfaces 240 and the compliant layer 250. For example, the exterior surfaces 240 may be roughening, such as by chemical roughening or physical roughening. For further example, an adhesive may be used to bond the compliant layer 250 to the exterior surfaces 240.

In one embodiment, the compliant layer 250 may have a thickness 255 between about 1/16 inches to about ⅛ inches. In another embodiment, the compliant layer 250 may have a thickness 255 between about 1/64 inches to about 1/32 inches. In another embodiment, the compliant layer 250 may have a thickness 255 between about 1/64 inches to about ¾ inches. In another embodiment, the compliant layer 250 may have a thickness 255 between about 0.001 inches to about 5 inches.

The compliant layer 250 may have a certain thickness on one portion of the insert 150 and a different thickness on another portion of the same insert 150. In one embodiment, the compliant layer 250 may have a Shore A hardness of about 60. In another embodiment, the compliant layer 250 may have Shore D hardness of about 70. The compliant layer 250 may be a color that is different than a color of the buoyant member 120 such that the inserts 150 are easily detectable.

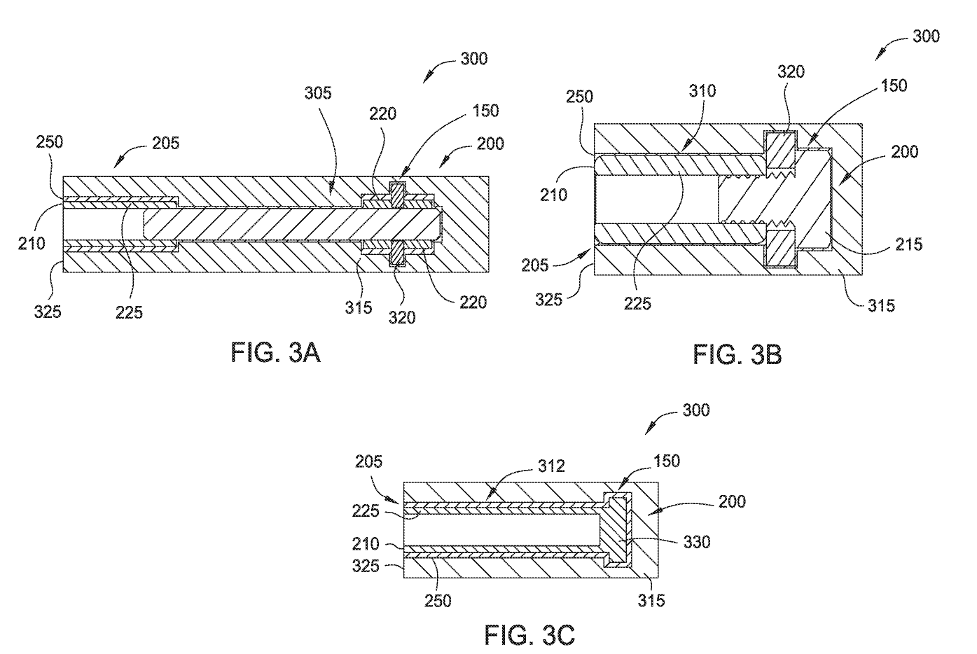

FIG. 3A is a sectional view of a lift insert 305 (such as inserts 150) embedded within a buoyant member 300 (such as buoyant member 120). FIG. 3B is a sectional view of a panel insert 310 (such as inserts 150) embedded within a buoyant member 300 (such as buoyant member 120). FIG. 3C is a sectional view of a single piece insert 312 (such as inserts 150) embedded within a buoyant member 300 (such as buoyant member 120).

The buoyant member 300 in all of FIGS. 3A-3C is formed out of a buoyant material 315, which can be the same material as the buoyant member 120, such as composite closed cell foam. The compliant layer 250 is disposed between the buoyant member 300 and the lift insert 305, the panel insert 310, and/or the single piece insert 312.

In FIG. 3A, the lift insert 305 includes a threaded sleeve 225 that may have a diameter within a range of 1/16 inches to 4 inches. A threaded portion or member of a lifting eye may be threaded into the threaded sleeve 225 of the lift insert 305 to attach the lifting eye to the buoyant member 300. One or more washers 320 may be coupled to the lift insert 305.

In FIG. 3B, the panel insert 310 includes a threaded sleeve 225 that may have a 5/16 inch diameter. A threaded portion or member of a protective panel may be threaded into the threaded sleeve 225 of the panel insert 310 to attach the protective panel to the buoyant member 300. One or more washers 320 may be coupled to the panel insert 310.

In FIG. 3C, the single piece insert 312 includes a threaded sleeve 225 that is integral with a larger diameter head portion 330. The single piece insert 312 may be machined or cast. The single piece insert 312 has a monolithic body and may be used as a lift insert or a panel insert.

The lift insert 305, the panel insert 310, and the single piece insert 312 are each covered with the compliant layer 250 and are at least partially embedded within the buoyant material 315. The threaded sleeves 225 and a portion of the compliant layer 250 are exposed or visible from an outer surface 325 of the buoyant material 315. The threaded sleeves 225 may be substantially flush with the outer surface 325 of the buoyant material 315 but are exposed for connection with a peripheral device as discussed above. The inserts 150 (including the lift insert 305, the panel insert 310, and the single piece insert 312) with the compliant layer 250 help minimize or eliminate cracking of the buoyant member 120 by distributing loads experienced by the inserts 150 across greater areas of the buoyant member 120.

While the foregoing is directed to embodiments of the disclosure, other and further embodiments may be devised without departing from the basic scope thereof, and the scope thereof is determined by the claims that follow.

1. A subsea system, comprising:
a buoyant member;
an insert comprising a monolithic body at least partially embedded within the buoyant member, wherein the insert comprises a retention member having female threads configured to attach a peripheral device to the buoyant member; and
a compliant layer disposed between the insert and the buoyant member configured to minimize cracking of the buoyant member when a load is applied to the insert.

2. The system of claim 1, wherein the compliant layer comprises an elastomeric material.

3. The system of claim 1, wherein the compliant layer comprises at least one of polycarbonate, polyepoxide, polyurethane, rubber, high density polyethelene, fluoroelastomer (FKM), and acrylonitrile butadiene styrene (ABS).

4. The system of claim 1, wherein the compliant layer has a thickness between 1/16 inches and ⅛ inches.

5. The system of claim 1, wherein the compliant layer has a thickness between 0.001 inches and 5 inches.

6. The system of claim 1, wherein at least a portion of the exterior surface of the insert is covered with the compliant layer.

7. The system of claim 6, wherein the entire exterior surface of the insert is covered with the compliant layer.

8. The system of claim 1, wherein the buoyant member comprises a composite closed cell foam.

9.-10. (canceled)

11. The system of claim 1, wherein the monolithic body of the insert comprises a single machined component.

12. The system of claim 1, wherein the monolithic body of the insert comprises a single cast component.

13. The system of claim 1, wherein the compliant layer is applied to surfaces of the buoyant member where the insert is at least partially embedded.

14. The system of claim 1, wherein an end portion of the insert and an end portion of the compliant layer are both flush with an outer surface of the buoyant member.
